(19) United States
(12) Patent Application Publication
(10) Pub. No.: US 2022/0259775 A1
(43) Pub. Date: Aug. 18, 2022

(54) AIRBAG FABRIC

(71) Applicant: PHP FIBERS GMBH, Obernburg (DE)

(72) Inventors: Marianne BONGARTZ, Freudenberg (DE); Andreas FLACHENECKER, Essen (DE); Christian VIETH, Wörth (DE); Volker SIEJAK, Duisburg (DE)

(73) Assignee: PHP FIBERS GMBH, Obernburg (DE)

(21) Appl. No.: 17/625,430

(22) PCT Filed: Jul. 7, 2020
(86) PCT No.: PCT/EP2020/069107

§ 371 Date: Jan. 7, 2022

(30) Foreign Application Priority Data
Jul. 12, 2019 (EP) 19185915.6

(51) Int. Cl. D02G 3/44

(52) U.S. Cl. CPC D02G 3/446; D10B 2331/02; D10B 2505/124

(57) ABSTRACT

An airbag fabric made of polyamide filaments, wherein the polyamide filaments are made of at least 60% by weight of a bio-based monomer.

### DESCRIPTION

The invention relates to an airbag fabric which is produced from polyamide filaments, and a method of producing an airbag fabric of this sort.

Airbag fabrics are preferably produced from filaments on a polyamide basis, since polyamides have a good property combination of strength, weight and thermal stability. Like every other thermoplastic polymer, polyamides are also produced from components of crude oil.

The production methods of these polymers are considered to be harmful to the environment, since the production of crude oil, from transport and processing until the finished polymer, involves many energy-consuming steps. In the process, large quantities of carbon dioxide are released. The carbon dioxide which is released in the process contributes to the greenhouse effect which is responsible for global warming.

In addition, the earth's reserves of crude oil are finite and will run out in the foreseeable future.

A further factor which forces the discovery of more environmentally-friendly solutions is the changed attitude of humankind. Plagued by periods of heat and dryness, heavy rain events, storms and other natural catastrophes, which are caused by global warming, humankind is striving to act in a more environmentally friendly manner in all walks of life and accordingly also, when purchasing products, to ensure that these products do not (massively) harm the environment.

This results in the necessity of providing new methods and materials which on the one hand release less carbon dioxide in their production and thereby have less influence on the environment, and on the other hand provide independence from crude oil, a resource which is being depleted.

Documents U.S. Pat. No. 8,231,950 B2 and US 2013/0022771 A1 propose the production of block copolymers of polyether and polyamides, which are obtained at least partially from renewable raw materials.

Document WO 2010/089902 A1 proposes the use of PEBA, a polyether block amide, for the production of components e.g. in cars or computers. PEBA is also obtained at least partially from renewable raw materials.

In document JP 2013 049930, a polyamide fibre is disclosed which has for example decanedioic acid as a component.

None of the documents discloses an airbag fabric according to claim 1.

The task of the present invention involves making available an airbag fabric which consists of components which are produced at least partially from renewable raw materials and thus smaller quantities of carbon dioxide are released in the production.

The task according to the invention is solved by an airbag fabric which is produced from polyamide filaments, wherein the polyamide filaments are made of at least 60% by weight of a bio-based monomer, based on the total weight of the polyamide.

Polyamides are linear polymers with regularly repeating amide bonds along the main chain. The amide bonds result e.g. from the condensation of carboxylic acid groups with amino groups.

The skilled person is aware that polyamides can be produced both from one single type of monomer, wherein the type of monomer has both an amino group and a carboxylic acid group (e.g. caprolactam), and from two types of monomers, wherein one type of monomer has two amino groups and the other type of monomer has two carboxylic acid groups. Also possible are copolymers of the previously mentioned types of monomers.

For the rational designation of the aliphatic polyamides, abbreviations exist which consist of the letters PA and subsequent numbers. In this regard, the numbers specify how many carbon atoms are present in the monomers. In the case of an abbreviation PA6, this means that the polyamide is constructed of a single type of monomer with one amino group and one carboxylic acid group, which has six carbon atoms. Accordingly, PA6 is the polyamide made of caprolactam. In the case of a polyamide with the abbreviation PA6,6, this means that the polyamide is constructed of two monomers and the first number specifies how many carbon atoms the monomer with the two amino groups possesses and the second number specifies how many carbons the monomer with the two carboxylic acid groups has. Accordingly, PA6,6 is a polyamide constructed of hexamethylene diamine (1,6-hexanediamine) and adipic acid (hexanedioic acid). In the case of co-polyamides, the numbers are placed behind one another and separated by a forwards-slash “/”, such as e.g. PA6/6,6.

The polyamides of which the filaments consist contain bio-based monomers. This means that the monomers are obtained or produced from renewable raw materials. In this regard, it is possible for all monomers to be bio-based, or that a proportion is bio-based and another proportion of the monomers is produced from crude oil. For example, it is possible in the case of a polyamide which is constructed of two types of monomers, that the monomer with two carboxylic acid groups is bio-based and the monomer with two amino groups is manufactured from crude oil.

Many alkanedioic acids can be obtained from renewable raw materials by means of chemical, biochemical or biological methods. Hereinafter a list of the possible diacids which can be obtained from renewable raw materials:
butanedioic acid (e.g. from glucose by means of fermentation)
hexanedioic acid (e.g. from glucose)
heptanedioic acid (e.g. from castor oil)
nonanedioic acid (e.g. from oleic acid by means of ozonolysis)
decanedioic acid (e.g. from castor oil)
undecanedioic acid (e.g. from castor oil)
dodecanedioic acid (e.g. from coconut oil or palm oil by means of bio fermentation of capric acid)
tridecanedioic acid (e.g. from the seeds of crucifers by ozonolysis of the erucic acid contained)
tetradecanedioic acid (e.g. from coconut oil or palm oil by means of bio fermentation of myristic acid)
hexadecanedioic acid (e.g. from palm oil by means of bio fermentation of the palmitic acid)

The corresponding diamines can be produced by amination of the alkanedioic acids.

Insofar as the polyamide consists only of monomers which are produced from renewable raw materials, less energy is used and less carbon dioxide is released in the production of a polyamide of this sort, since in this regard for example there is no need for the production of crude oil, the transport of the crude oil and the refining of the crude oil. Accordingly, polymers which are produced partially or completely from renewable raw materials are less polluting for the environment.

In a preferred embodiment, the filaments comprise a polyamide which is selected from a group which contains PA4,10, PA6,10, PA8,10 or PA10,10 as well as co-polymers and/mixtures thereof, wherein in each case one of the monomers is bio-based.

The polyamides PA4,10, PA6,10 and PA10,10 have a lower density than PA6,6 and PA6. Thus, in the case of an airbag, filaments of PA4,10, PA6,10 and PA10,10 containing, the weight can be reduced, which reduces costs and saves raw materials.

A further advantage of these polymers is that they absorb lower proportions of moisture, which results in a further weight reduction. The proportion of moisture in polymer is measured at 65% RH (relative humidity) and at a temperature of 20° C. according to EN ISO 62 : 2008-05.

In this regard, yarns which consist of PA4,10, PA6,10 and PA10,10 filaments have similar or improved properties in the case of tear strength, elongation at break and modulus. The tear strength, the elongation at break and the modulus are measured according to DIN EN ISO 2062.

The bio-based monomer is especially preferably decanedioic acid (sebacic acid).

In a preferred embodiment, the decanedioic acid is obtained from castor oil.

An advantage of the decanedioic acid is that it can be obtained from renewable raw materials. In this regard, castor oil is obtained from the seed oil of several plant types and converted into decanedioic acid by means of an alkaline cleavage.

An advantage of castor oil is that it contains the highest proportion of ricinoleic acid. The castor oil is here obtained from the seeds of the castor bean (Ricinus communis).

In a further embodiment according to the invention, the polyamide filament consists of at least 63% by weight, preferably of at least 70% by weight and most preferably of 100% by weight of bio-based monomers, based on the total weight of the polyamide.

The task according to the invention is also solved by a method for producing an airbag fabric, which comprises the following steps:

a) spinning filaments of a polyamide, wherein the polyamide consists of at least 60% by weight of a bio-based monomer,

b) producing the airbag-fabric from the polyamide filaments produced in this manner.

In a special embodiment of the invention, the filaments are spun from a polyamide which contains PA4,10, PA6,10, PA8,10 or PA10,10 as well as co-polymers and/mixtures thereof.

In a preferred embodiment of the method according to the invention, the bio-based monomer is decanedioic acid (sebacic acid).

In a further preferred embodiment of the method according to the invention, the decanedioic acid is obtained from castor oil.

In an especially preferred embodiment, the filaments are spun from a polyamide which consists of at least 63% by weight, preferably of at least 70% by weight and most preferably of 100% by weight of bio-based monomers, based on the total weight of the polyamide.

### EXAMPLES

### Example 1

A PA4,10 yarn is produced with a total denier of 235 dtex with a filament number of 36. The polymer used is produced from the monomers tetramethylene diamine and decanedioic acid. The tetramethylene diamine was produced from non-renewable raw materials and the decanedioic acid was produced from castor oil. Thus, the polymer consists of 70% by weight of monomers which are produced from renewable raw materials, based on the total weight of the polymer.

### Example 2

A PA6,10 yarn is produced with a total denier of 235 dtex with a filament number of 36. The polymer used is produced from the monomers hexamethylene diamine and decanedioic acid. The hexamethylene diamine was produced from non-renewable raw materials and the decanedioic acid was produced from castor oil. Thus, the polymer consists of 63% by weight of monomers which are produced from renewable raw materials, based on the total weight of the polymer.

### Example 3

A PA10,10 yarn is produced with a total denier of 235 dtex with a filament number of 36. The polymer used is produced from the monomers decamethylene diamine and decanedioic acid. The decamethylene diamine and the decanedioic acid were produced from castor oil. Thus, the polymer consists of 100% by weight of monomers which are produced from renewable raw materials, based on the total weight of the polymer.

### Comparison Example 1

A PA6 yarn is produced with a total denier of 235 dtex with a filament number of 36. The polyamide PA6 consists of monomers which are produced from non-renewable raw materials.

### Comparison Example 2

A PA6,6 yarn is produced with a total denier of 235 dtex with a filament number of 36. The polyamide PA6,6 consists of monomers which are produced from non-renewable raw materials.

| | | | | Comparison | Comparison |
|---|---|---|---|---|---|
| | Example 1 | Example 2 | Example 3 | example 1 | example 2 |
| polymer | PA4,10 | PA6,10 | PA10,10 | PA6 | PA6,6 |
| melting | 250 | 223 | 203 | 215 | 255 |
| temperature | | | | | |
| Tₘ [° C.] | | | | | |
| density | 1.09 | 1.04 | 1.02 | 1.13 | 1.14 |
| [g/cm³] | | | | | |
| moisture | 1.90 | 1.60 | 0.90 | 3.10 | 2.70 |
| content [%] | | | | | |
| tear | 73 | 71 | 45 | 55 | 70 |
| strength | | | | | |
| [cN/Tex] | | | | | |
| elongation | 18 | 18 | 23 | 17 | 20 |
| at break [%] | | | | | |
| modulus [%] | 6.8 | 7.3 | 6.7 | 7.5 | 7.5 |
| hot air | 6.8 | 7.2 | 11.1 | 5.4 | 6.3 |
| shrinkage [%] | | | | | |

1. An airbag fabric, produced from polyamide filaments, wherein the polyamide filaments consist of at least 60% by weight of a bio-based monomer.

2. The airbag fabric according to claim 1, wherein the polyamide filaments comprise a polyamide which is selected from the group which contains PA4,10, PA6,10, PA8,10 or PA10,10 as well as copolymers and/or mixtures thereof.

3. The airbag fabric according to claim 1, wherein the bio-based monomer is decanedioic acid (sebacic acid).

4. The airbag fabric according to claim 3, wherein the decanedioic acid is obtained from castor oil.

5. The airbag fabric according to claim 1, wherein the polyamide filaments consist of at least 63% by weight, based on the total weight of the polyamide.

6. A method for producing an airbag fabric, which comprises the following steps:
a) spinning filaments of a polyamide, wherein the polyamide consists of at least 60% by weight of a bio-based monomer,
b) producing the airbag-fabric from the polyamide filaments produced in this manner.

7. The method according to claim 6, wherein the polyamide filaments are spun from a polyamide which is selected from a group which contains PA4,10, PA6,10, PA8,10 or PA10,10 as well as co-polymers and/or mixtures thereof.

8. The method according to claim 6, wherein the bio-based monomer is decanedioic acid (sebacic acid).

9. The method according to claim 8, wherein the decanedioic acid is obtained from castor oil.

10. The method according to claim 6, wherein the polyamide filaments are spun from a polyamide consisting of at least 63% by weight, based on the total weight of the polyamide.
